(19) United States
(12) Patent Application Publication
(10) Pub. No.: US 2016/0108326 A1
(43) Pub. Date: Apr. 21, 2016

(54) CLOUD POINT IMPROVEMENT FOR PARTIAL CONVERSION HYDROCRACKING UNITS

(71) Applicant: UOP LLC, Des Plaines, IL (US)

(72) Inventors: Ralph Davis, Woodstock, IL (US); Jennifer L. Davis, Woodstock, IL (US); Vernon L. Mallett, Schaumburg, IL (US)

(21) Appl. No.: 14/516,287

(22) Filed: Oct. 16, 2014

(51) Int. Cl. C10G 69/02; B01J 19/24

(52) U.S. Cl. CPC C10G 69/02; B01J 19/245; B01J 2219/24

(57) ABSTRACT

Methods and apparatus for improving the cold flow properties of diesel are described. The methods include hydrocracking a hydrocarbon feed to provide a reactor effluent comprising a product mixture comprising diesel, kerosene, and naphtha, and unconverted feed. The reactor effluent is separated in an enhanced hot separator into an overhead vapor stream comprising the product mixture and a liquid bottoms stream comprising the unconverted feed. The overhead vapor stream is contacted with a dewaxing catalyst in a finishing reaction zone to convert a portion of n-paraffins in the product mixture to iso-paraffins. The effluent from the finishing reaction zone is separated in a high pressure separator into an overhead stream comprising gases and a liquid stream comprising the product mixture. The liquid stream from the high pressure separator is separated into at least a diesel stream in a fractionation zone.

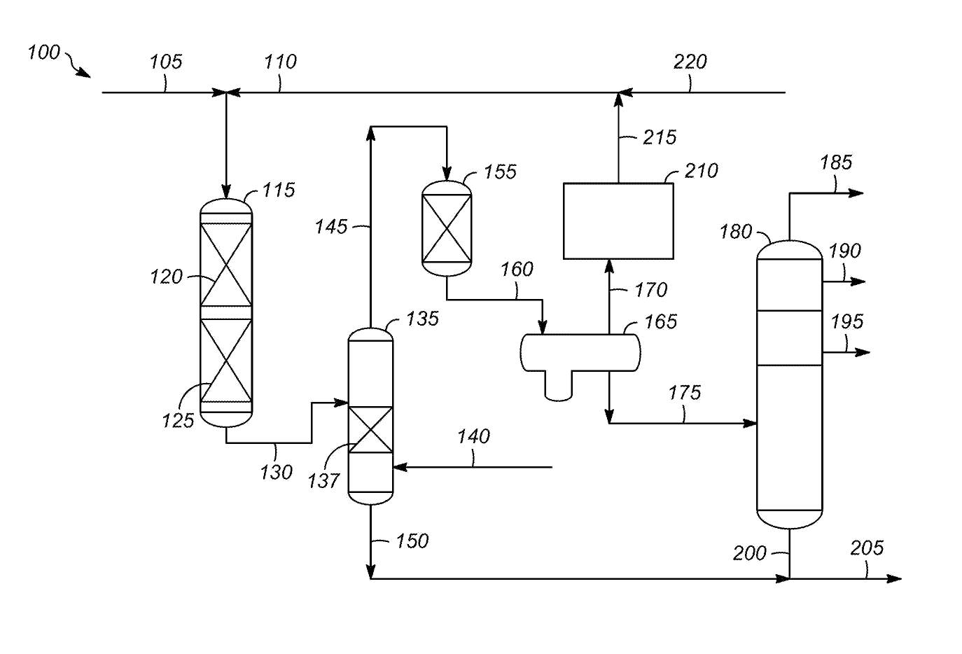

### BACKGROUND OF THE INVENTION

Hydrocracking refers to a process in which hydrocarbons crack in the presence of hydrogen and catalyst to lower molecular weight hydrocarbons. Depending on the desired output, the hydrocracking zone may contain one or more beds of the same or different catalyst. Hydrocracking is a process used to crack hydrocarbon feeds such as vacuum gas oil (VGO) to diesel including kerosene and gasoline motor fuels.

Mild hydrocracking can be used as a stand-alone process or upstream of a fluid catalytic cracking (FCC) or other process unit to improve the quality of an unconverted oil that can be fed to the downstream FCC unit, while converting part of the feed to lighter products such as diesel. As world demand for diesel motor fuel is growing relative to gasoline motor fuel, mild hydrocracking is being considered for biasing the product slate in favor of diesel at the expense of gasoline. Mild hydrocracking may be operated at a lower severity than partial or full conversion hydrocracking to balance production of diesel with the FCC unit, which is primarily used to make naphtha. Partial or full conversion hydrocracking is used to produce diesel with less yield of the unconverted oil which can be fed to a downstream unit.

Due to environmental concerns and newly enacted rules and regulations, saleable diesel must meet lower and lower limits on contaminants, such as sulfur and nitrogen. New regulations require essentially complete removal of sulfur from diesel. For example, the ultra low sulfur diesel (ULSD) requirement is typically less than about 10 wppm sulfur.

The cetane rating of diesel can be improved by saturating aromatic rings. Catalysts for saturating aromatic rings are typically noble metal or base metal catalysts.

For many customers, the cloud point or other cold flow properties limit the diesel cutpoint. The cloud point and pour point of diesel can be improved by catalytic dewaxing processes wherein n-paraffins are isomerized or converted into shorter, branched iso-paraffins. Ideally, the catalytic dewaxing process converts a relatively large proportion of n-paraffins to iso-paraffins with minimal cracking of the diesel range materials to lighter products, such as naphtha range products. Catalytic dewaxing (isomerization) catalysts can also be noble metal or base metal catalysts.

However, it is difficult to improve the cold flow properties of the diesel stream with a dewaxing catalyst when the diesel stream is not the highest boiling range material.

Therefore, there is a need for a process to improve the cloud point and/or cold flow properties of a diesel stream.

### SUMMARY OF THE INVENTION

One aspect of the invention is a method of improving the cold flow properties of diesel. In one embodiment, the method includes hydrocracking a hydrocarbon feed in a hydrocracking zone in the presence of a hydrocracking catalyst under hydrocracking conditions to provide a reactor effluent comprising a product mixture comprising diesel, kerosene, and naphtha, and unconverted feed. The reactor effluent is separated in an enhanced hot separator into an overhead vapor stream comprising the product mixture and a liquid bottoms stream comprising the unconverted feed. The overhead vapor stream from the enhanced hot separator is contacted with a dewaxing catalyst in a finishing reaction zone to convert a portion of n-paraffins in the product mixture to iso-paraffins for improved cold flow properties. The effluent from the finishing reaction zone is separated in a high pressure separator into an overhead stream comprising gases and a liquid stream comprising the product mixture. The liquid stream from the high pressure separator is separated into at least a diesel stream in a fractionation zone.

Another aspect of the invention is an apparatus for improving the cold flow properties of diesel. In one embodiment, the apparatus includes a hydrocracking zone having an inlet and an outlet; an enhanced hot separator having a fluid inlet, a gas inlet, an overhead outlet, and a bottoms outlet, the fluid inlet of the enhanced hot separator being in fluid communication with the outlet of the hydrocracking zone, the stripping gas inlet being in fluid communication with a stripping gas source, the enhanced hot separator containing a bed of packing; a finishing reactor containing a dewaxing catalyst having an inlet and an outlet, the inlet being in fluid communication with the overhead outlet of the enhanced hot separator; a high pressure separator having an inlet, a gas outlet, and a liquid outlet, the inlet of the high pressure separator being in fluid communication with the outlet of the finishing reactor; and a fractionation zone having an inlet and at least one outlet, the inlet of the fractionation zone being in fluid communication with the liquid outlet of the high pressure separator.

### BRIEF DESCRIPTION OF THE DRAWING

The FIGURE illustrates one embodiment of a process of the present invention.

### DETAILED DESCRIPTION OF THE INVENTION

The present invention meets provides a process to improve the cold flow properties of a diesel stream. The process involves partial conversion of a feed in a hydrocracking reaction zone including a hydrotreating and hydrocracking catalyst. The reactor effluent is sent to an enhanced hot separator to strip diesel and lighter materials from the unconverted oil. The diesel and lighter material along with recycle gas and stripping hydrogen are removed from the enhanced hot separator in an overhead stream. The overhead stream is sent to a finishing reaction zone containing a dewaxing catalyst to convert a portion of the n-paraffins in the product mixture to iso-paraffins for improved diesel cold flow properties, such as cloud point improvement. The effluent from the finishing reactor is sent to a high pressure separator. The liquid stream from the high pressure separator is sent to a fractionation zone.

The cloud point specification for the diesel pool varies with the location and the time of year. For example, diesel to be sold in Chicago in the winter will have a lower cloud point than diesel to be sold in the winter in Texas. There is a diesel yield loss when the cloud point is reduced, and the yield loss increases with increasing cloud point reduction. Consequently, the refinery will only reduce the cloud point as much as is needed to meet the cloud point requirement. The present invention allows a cloud point reduction of about 5° C. or more.

The FIGURE illustrates one embodiment of the process 100. The hydrocarbon feed 105 is mixed with hydrogen stream 110 and sent to hydrocracking zone 115.

The hydrocracking feed can vary. Typical feeds include, but are not limited to hydrocarbonaceous streams having components boiling above about 288° C. (550° F.), such as atmospheric gas oils, VGO, deasphalted, vacuum, and atmospheric residua, coker distillates, straight run distillates, solvent-deasphalted oils, pyrolysis-derived oils, high boiling synthetic oils, cycle oils, hydrocracked feeds, catalytic cracker distillates, and the like.

Hydrocracking zone 115 can include a hydrotreating section 120 and a hydrocracking section 125.

The hydrocracking zone 115 may comprise one or more vessels, multiple beds of catalyst in each vessel, and various combinations of hydrotreating catalyst and hydrocracking catalyst in one or more vessels. In some aspects, the hydrocracking reaction provides a partial total conversion of about 20 vol-% to about 60 vol-% of the hydrocarbon feed to products boiling below the diesel boiling range. The hydrotreating section 120 may include hydrotreating catalyst for the purpose of demetallizing, desulfurizing or denitrogenating the hydrocracking feed.

As used herein, the term “conversion” means conversion of feed to material that boils at or below the diesel boiling range. The cut point of the diesel boiling range is between about 343° C. (650° F.) and about 399° C. (750° F.) using the True Boiling Point distillation method.

As used herein, the term “diesel boiling range” means hydrocarbons boiling in the range of between about 132° C. (270° F.) and about 399° C. (750° F.) using the True Boiling Point distillation method.

As used herein, the term “True Boiling Point” (TBP) means a test method for determining the boiling point of a material which corresponds to ASTM D2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio. The hydrocracking zone 115 may be operated at mild hydrocracking conditions. Mild hydrocracking conditions will provide about 20 to about 60 vol-% total conversion of the hydrocarbon feed to product boiling below the diesel cut point. In mild hydrocracking, converted products are biased in favor of diesel. In a mild hydrocracking operation, the hydrotreating catalyst has just as much or a greater conversion role than hydrocracking catalyst. Conversion across the hydrotreating catalyst may be a significant portion of the overall conversion. If the hydrocracking zone 115 is intended for mild hydrocracking, it is contemplated that the hydrocracking zone 115 may be loaded with all hydrotreating catalyst, all hydrocracking catalyst, or some beds of hydrotreating catalyst and some beds of hydrocracking catalyst. In the last case, the beds of hydrocracking catalyst may typically follow beds of hydrotreating catalyst.

The hydrocracking zone 115 in the FIGURE has two beds in one reactor vessel. If mild hydrocracking is desired, it is contemplated that the first catalyst bed comprises hydrotreating catalyst and the second catalyst bed comprises hydrocracking catalyst.

At mild hydrocracking conditions, the feed is selectively converted to products such as diesel and kerosene with a low yield of lighter hydrocarbons such as naphtha and lighter hydrocarbons (e.g., propane and/or liquefied petroleum gas). The unit is operated at a pressure suitable for hydrogenation of the bottom product. The mild hydrocracking conditions are described below.

In one aspect, for example, when a balance of middle distillate and gasoline is preferred in the converted product, mild hydrocracking may be performed in the hydrocracking zone with hydrocracking catalysts that utilize amorphous silica-alumina bases or low-level zeolite bases combined with one or more Group VIII or Group VIB metal hydrogenating components. In another aspect, when middle distillate is significantly preferred in the converted product over gasoline production, partial or full hydrocracking may be performed in the hydrocracking zone 115 with a catalyst which comprises, in general, any crystalline zeolite cracking base upon which is deposited a Group VIII metal hydrogenating component. Additional hydrogenating components may be selected from Group VIB for incorporation with the zeolite base.

The zeolite cracking bases are sometimes referred to in the art as molecular sieves and are usually composed of silica, alumina and one or more exchangeable cations such as sodium, magnesium, calcium, rare earth metals, etc. They are further characterized by crystal pores of relatively uniform diameter between about 4 and about 14 Angstroms (10⁻¹⁰ meters). It is preferred to employ zeolites having a relatively high silica/alumina mole ratio between about 3 and about 12. Suitable zeolites found in nature include, for example, mordenite, stilbite, heulandite, ferrierite, dachiardite, chabazite, erionite and faujasite. Suitable synthetic zeolites include, for example, the B, X, Y and L crystal types, e.g., synthetic faujasite and mordenite. The preferred zeolites are those having crystal pore diameters between about 8-12 Angstroms (10⁻¹⁰ meters), wherein the silica/alumina mole ratio is about 4 to 6. One example of a zeolite falling in the preferred group is synthetic Y molecular sieve.

The natural occurring zeolites are normally found in a sodium form, an alkaline earth metal form, or mixed forms. The synthetic zeolites are nearly always prepared first in the sodium form. In any case, for use as a cracking base it is preferred that most or all of the original zeolitic monovalent metals be ion-exchanged with a polyvalent metal and/or with an ammonium salt followed by heating to decompose the ammonium ions associated with the zeolite, leaving in their place hydrogen ions and/or exchange sites which have actually been decationized by further removal of water. Hydrogen or “decationized” Y zeolites of this nature are more particularly described in U.S. Pat. No. 3,130,006.

Mixed polyvalent metal-hydrogen zeolites may be prepared by ion-exchanging first with an ammonium salt, then partially back exchanging with a polyvalent metal salt and then calcining. In some cases, as in the case of synthetic mordenite, the hydrogen forms can be prepared by direct acid treatment of the alkali metal zeolites. In one aspect, the preferred cracking bases are those which are at least about 10 percent, and preferably at least about 20 percent, metal-cation-deficient, based on the initial ion-exchange capacity. In another aspect, a desirable and stable class of zeolites is one wherein at least about 20 percent of the ion exchange capacity is satisfied by hydrogen ions.

The active metals employed in the preferred hydrocracking catalysts of the present invention as hydrogenation components are those of Group VIII, i.e., iron, cobalt, nickel, ruthenium, rhodium, palladium, osmium, iridium and platinum. In addition to these metals, other promoters may also be employed in conjunction therewith, including the metals of Group VIB, e.g., molybdenum and tungsten. The amount of hydrogenating metal in the catalyst can vary within wide ranges. Broadly speaking, any amount between about 0.05 percent and about 30 percent by weight may be used. In the case of the noble metals, it is normally preferred to use about 0.05 to about 2 wt-%.

The method for incorporating the hydrogenating metal is to contact the base material with an aqueous solution of a suitable compound of the desired metal wherein the metal is present in a cationic form. Following addition of the selected hydrogenating metal or metals, the resulting catalyst powder is then filtered, dried, pelleted with added lubricants, binders or the like if desired, and calcined in air at temperatures of, e.g., about 371° C. to about 648° C. (about 700° F. to about 1200° F.) in order to activate the catalyst and decompose ammonium ions. Alternatively, the base component may first be pelleted, followed by the addition of the hydrogenating component and activation by calcining.

The foregoing catalysts may be employed in undiluted form, or the powdered catalyst may be mixed and copelleted with other relatively less active catalysts, diluents or binders such as alumina, silica gel, silica-alumina cogels, activated clays and the like in proportions ranging between about 5 and about 90 wt-%. These diluents may be employed as such or they may contain a minor proportion of an added hydrogenating metal such as a Group VIB and/or Group VIII metal. Additional metal promoted hydrocracking catalysts may also be utilized in the process of the present invention which comprises, for example, aluminophosphate molecular sieves, crystalline chromosilicates and other crystalline silicates. Crystalline chromosilicates are more fully described in U.S. Pat. No. 4,363,718.

By one approach, the hydrocracking conditions may include a temperature from about 290° C. (550° F.) to about 468° C. (875° F.), preferably 343° C. (650° F.) to about 435° C. (815° F.), a pressure from about 3.5 MPa (500 psig) to about 20.7 MPa (3000 psig), a liquid hourly space velocity (LHSV) from about 1.0 to less than about 2.5 hr⁻¹ and a hydrogen rate of about 421 to about 2,527 Nm³/m³ oil (2,500-15,000 scf/bbl). If mild hydrocracking is desired, conditions may include a temperature from about 315° C. (600° F.) to about 441° C. (825° F.), a pressure from about 5.5 to about 13.8 MPa (gauge) (800 to 2000 psig) or more typically about 6.9 to about 11.0 MPa (gauge) (1000 to 1600 psig), a liquid hourly space velocity (LHSV) from about 0.5 to about 2 hr⁻¹ and preferably about 0.7 to about 1.5 hr⁻¹ and a hydrogen rate of about 421 to about 1,685 Nm³/m³ oil (2,500-10,000 scf/bbl).

The hydrocarbon feed 105 may be heat exchanged (not shown) with the reactor effluent 130 and further heated in a fired heater (not shown) before entering the hydrocracking zone 115 for hydrocracking the hydrocarbon stream to lower boiling hydrocarbons.

The reactor effluent 130 exits the hydrocracking zone 115 and is sent to the enhanced hot separator (EHS) 135. The reactor effluent 130 comprises a liquid phase and a vapor phase. The liquid phase comprises the unconverted oil, and the vapor phase comprises diesel and lighter hydrocarbons. The vapor phase may also comprise hydrogen, water vapor, and perhaps sulfur components such as hydrogen sulfide, or phosphorous components such as phosphine, or nitrogen compounds such as ammonia.

The EHS 135 is a high pressure stripping column. The function of the EHS 135 is to strip the diesel and lighter material from the unconverted oil in the reactor effluent 130.

The reactor effluent 130 enters the EHS 135 on the side of the vessel. There is bed of packing 137 in the EHS 135 below where the reactor effluent 130 enters the EHS 135. The stripping hydrogen 140 enters below the bed of packing 137. The liquid in the reactor effluent 130 flows down through the bed of packing 137. The stripping hydrogen 140 passes up through the bed of packing 137. The stripping hydrogen 140 and bed of packing 137 provide increased separation of the diesel from the unconverted oil compared with a hot separator without packing or stripping gas.

The reactor effluent 130 is separated into an overhead stream 145, which comprises hydrocarbon vapor, various gases, and the stripping hydrogen gas, and a bottoms stream 150, which comprises unreacted feed.

The processing conditions will vary. Process simulations can determine what temperature would be needed to separate the diesel from the unconverted oil. The pressure will be the same as the pressure of the high pressure separator overhead stream 145 containing the diesel and lighter hydrocarbons, and various gases is sent to finishing reaction zone 155 which contains dewaxing catalyst.

The dewaxing catalyst may contain silicalite, MFI zeolites and silicoaluminophosphates (SAPOs). Dewaxing using SAPOs and other materials is described in some detail in U.S. Pat. Nos. 4,880,760; 4,859,311; 4,867,861; 4,877,581; 5,114,563 and 5,288,395. The teaching of these references in regard to catalyst compositions and operating conditions for dewaxing is incorporated herein.

A preferred dewaxing catalyst used in the subject process comprises a non-zeolitic molecular sieve (NZMS) material essentially free of Y zeolite. While some commercial catalysts contain a zeolitic material, the dewaxing catalyst of the subject process is preferably free of molecular sieves referred to in the art as zeolites such as. Zeolites are described in the previously cited U.S. Pat. No. 4,818,369.

The preferred NZMS-based catalyst dewaxes the feed by selective isomerization of long chain paraffins rather than by cracking of the paraffins as done by some other zeolitic molecular sieves. This results in the subject process producing less light hydrocarbon by-products and providing higher yields of middle distillate products.

Non-zeolitic molecular sieves (NZMS) materials contain framework tetrahedral units (TO₂) of aluminum (AlO₂), phosphorus (PO₂) and at least one additional element EL (ELO₂). Non-zeolitic molecular sieves include the “ELAPSO” molecular sieves as disclosed in U.S. Pat. No. 4,793,984 (Lok et al.), “SAPO” molecular sieves of U.S. Pat. No. 4,440,871 (Lok et al.) and crystalline metal aluminophosphates—MeAPOs where “Me” is at least one of Mg, Mn, Co and Zn—as disclosed in U.S. Pat. No. 4,567,029 (Wilson et al.). Framework As, Be, B, Cr, Fe, Ga, Ge, Li, Ti or V and binary metal aluminophosphates are disclosed in various species patents.

Also relevant to the present invention is U.S. Pat. No. 4,758,419 (Lok et al.), which discloses MgAPSO non-zeolitic molecular sieves and which is incorporated herein by reference. MgAPSO sieves have a microporous crystalline framework structure of MgO₂⁻², AlO₂⁻, PO₂⁺, and SiO₂ tetrahedral units having an empirical chemical composition on an anhydrous basis expressed by the formula:

mR:(Mg_{w}AlₓP_{y}Si_{z})O₂

wherein “R” represents at least one organic templating agent present in the intracrystalline pore system; “m” represents the molar amount of “R” present per mole of (Mg_{w}AlₓP_{y}Si_{z})O₂ and has a value of zero to about 0.3; and “w”, “x”, “y” and “z” represent the mole fractions of element magnesium, aluminum, phosphorus and silicon, respectively, present as tetrahedral oxides. The mole fraction of each framework constituent of the NZMS is defined as a compositional value which is plotted in phase diagrams of U.S. Pat. No. 4,758,419. The mole fractions “w”, “x”, “y” and “z” are generally defined as being within the limiting compositional values set out therein.

The nomenclature employed herein to refer to the members of the class of MgAPSOs is consistent with that employed in the aforementioned patents. A particular member of a class is generally referred to as a “−n” species wherein “n” is an integer, e.g., MgAPSO-11, MgAPSO-31 and MgAPSO-41. The especially preferred species of the present invention is MgAPSO-31 having a characteristic X-ray powder diffraction pattern which contains at least the d-spacings set forth below:

| 2Θ | d | Relative Intensity |
|---|---|---|
| 8.4-9.501 | 10.53-9.3084 | w-s |
| 20.2-20.4 | 4.40-4.35 | m |
| 22.0-22.1 | 4.04-4.022 | m |
| 22.5-22.7 | 3.952-3.92 | vs |
| 23.15-23.35 | 2.831-2.814 | w-m |

The dewaxing catalyst is preferably prepared by combining the NZMS material with an inorganic oxide support material suitable for formation of catalyst particles. The support material should be highly porous and have a surface area of about 25 to about 500 m²/g, uniform in composition and relatively refractory to the conditions utilized in the hydrocarbon conversion process. The catalyst may comprise a variety of support materials which have traditionally been utilized in hydrocarbon conversion catalysts such as: (1) refractory inorganic oxides including alumina, titanium dioxide, zirconium dioxide, chromium oxide, zinc oxide, magnesia, thoria, boria, silica-alumina, silica-magnesia, chromia-alumina, alumina-boria, silica-zirconia, etc.; (2) silica or silica gel, clays and silicates including those synthetically prepared and naturally occurring, which may or may not be acid treated, for example attapulgus clay, diatomaceous earth, fuller's earth, kaolin, kieselguhr, etc.; and, (3) combinations of materials from one or more of these groups.

The preferred support materials are refractory inorganic oxides, most preferably alumina. Suitable aluminas are the crystalline aluminas known as the gamma-, eta-, and theta-aluminas. Excellent results are obtained with a matrix of substantially pure gamma-alumina. Whichever type of matrix is employed, it may be activated prior to use by one or more treatments including but not limited to drying, calcination, and steaming.

The dewaxing catalyst may contain a positive amount of a metal hydrogenation component. Unless otherwise specified the concentration of any metal component of a catalyst described herein is intended to indicate the amount of metal present in terms of the elemental metal as compared to a sulfide or oxide. The metal hydrogenation component may comprise a Group VIII metal such as nickel or cobalt. A preferred metal component for the dewaxing catalyst is a base metal chosen from the group consisting of nickel, tungsten and molybdenum or a mixture of one of these metals. It is, however, contemplated that ruthenium may be a suitable sulfur resistant metal component for the dewaxing catalyst when used at a low metal component level. Platinum and/or palladium can also be employed as the metal component. The metal component of the dewaxing catalyst may exist within the final catalyst composite as a compound such as an oxide, sulfide, halide, oxysulfide, etc., or as an elemental metal or in combination with one or more other ingredients of the catalytic composition. It is presently preferred to employ a base metal component which exists in a fully sulfided state. The metal hydrogenation component is preferably present at a concentration of from about 0.01 to about 0.5 mass % of the NZMS component of the dewaxing catalyst, calculated on an elemental basis.

The dewaxing catalysts should have a surface area of about 200 to 700 square meters per gram, a pore diameter of about 20 to about 300 Angstroms, a pore volume of about 0.10 to about 0.80 milliliters per gram, and apparent bulk density within the range of from about 0.50 to about 0.90 gram/cc. Surface areas above 350 m²/g are greatly preferred.

The finishing reaction zone is operated at hydrodewaxing conditions which include a pressure of about 2 MPa (g) to 20.7 MPa (g), a temperature of about 250 to 500° C., liquid hourly space velocities (LHSV) of from about 0.1 to 100 hr⁻¹, and a hydrogen rate of about 421 to about 1,685 Nm³/m³ oil (2,500-10,000 scf/bbl). The conditions will be determined by the feedstock and the desired products.

An alumina component of the two catalysts used in the process may be any of the various hydrous aluminum oxides or alumina gels such as alpha-alumina monohydrate of the boehmite structure, alpha-alumina trihydrate of the gibbsite structure, beta-alumina trihydrate of the bayerite structure, and the like. One preferred alumina is referred to as Ziegler alumina and has been characterized in U.S. Pat. Nos. 3,852,190 and 4,012,313 as a by-product from a Ziegler higher alcohol synthesis reaction as described in Ziegler's U.S. Pat. No. 2,892,858. A second preferred alumina is presently available from the Conoco Chemical Division of Continental Oil Company under the trademark “Catapal”. The material is an extremely high purity alpha-alumina monohydrate (boehmite) which, after calcination at a high temperature, has been shown to yield a high purity gamma-alumina.

The composition and physical characteristics of the two catalysts such as shape and surface area are not considered to be limiting upon the utilization of the present invention. The catalysts may, for example, exist in the form of pills, pellets, granules, broken fragments, spheres, or various special shapes such as trilobal extrudates, disposed as a fixed bed within a reaction zone. Alternatively, the catalysts may be prepared in a suitable form for use in moving bed reaction zones in which the hydrocarbon charge stock and catalyst are passed either in countercurrent flow or in co-current flow. Another alternative is the use of a fluidized or ebulated bed reactor in which the charge stock is passed upward through a turbulent bed of finely divided catalyst, or a suspension-type reaction zone, in which the catalyst is slurried in the charge stock and the resulting mixture is conveyed into the reaction zone. The charge stock may be passed through the reactor(s) in either upward or downward flow.

The catalyst particles may be prepared by any known method in the art including the well-known oil drop and extrusion methods. A preferred form for the catalysts used in the subject process is an extrudate. A multitude of different extrudate shapes are possible, including, but not limited to, cylinders, cloverleaf, dumbbell and symmetrical and asymmetrical polylobates. It is also within the scope of this invention that the uncalcined extrudates may be further shaped to any desired form, such as spheres, by any means known to the art.

A spherical catalyst may be formed by use of the oil dropping technique such as described in U.S. Pat. Nos. 2,620,314; 3,096,295; 3,496,115 and 3,943,070 which are incorporated herein by reference. Other references describing oil dropping techniques for catalyst manufacture include U.S. Pat. Nos. 4,273,735; 4,514,511 and 4,542,113. The production of spherical catalyst particles by different methods is described in U.S. Pat. Nos. 4,514,511; 4,599,321; 4,628,040 and 4,640,807.

Hydrogenation components may be added to the catalysts before or during the forming of the catalyst particles, but the hydrogenation components of the dewaxing catalyst are preferably composited with the formed support by impregnation after the active component and inorganic oxide support materials have been formed to the desired shape, dried and calcined. Impregnation of the metal hydrogenation component into the catalyst particles may be carried out in any manner known in the art including evaporative, dip and vacuum impregnation techniques. In general, the dried and calcined particles are contacted with one or more solutions which contain the desired hydrogenation components in dissolved form. After a suitable contact time, the composite particles are dried and calcined to produce finished catalyst particles.

Hydrogenation components contemplated for use in the two catalysts are those catalytically active components selected from the Group VIB and Group VIII metals and their compounds. References herein to Groups of the Periodic Table are to the traditionally American form as reproduced in the fourth edition of Chemical Engineer's Handbook, J. H. Perry editor, McGraw-Hill, 1963. Generally, the amount of hydrogenation components present in the final catalyst composition is small compared to the quantity of the other above-mentioned support components. The hydrogenation components contemplated for inclusion in the catalysts used in the process include one or more metals chosen from the group consisting of molybdenum, tungsten, chromium, iron, cobalt, nickel, platinum, palladium, iridium, osmium, rhodium, ruthenium and mixtures thereof. The hydrogenation components will most likely be present in the oxide form after calcination in air and may be converted to the sulfide form if desired by contact at elevated temperatures with a reducing atmosphere comprising hydrogen sulfide, a mercaptan or other sulfur containing compound. When desired, a phosphorus component may also be incorporated into the aromatics saturation catalyst. If used phosphorus is normally present in the catalyst in the range of 1 to 30 wt. % and preferably 3 to 15 wt. % calculated as P₂O₅.

Hydroprocessing to effect the hydrogenation of aromatic compounds boiling in the diesel fuel or kerosene boiling ranges is a well-established commercial process. A study of the conditions useful in the saturation of diesel fuel aromatics, the effects of varying these conditions on product properties and other factors in using a specific commercially available hydrogenation catalyst is presented in an article at page 47 of the May 29, 1989 edition of the Oil and Gas Journal. A second article on the production of low aromatic hydrocarbon diesel fuel is presented at page 109 of the May 7, 1990 edition of the Oil and Gas Journal. These articles are incorporated herein by reference for their teaching in regard to the hydrogenation of middle distillates.

The effluent 160 from the finishing reaction zone 155 is sent to the high pressure separator 165 where it is separated into a overhead stream 170 and bottoms stream 175. The high pressure separator 165 may be operated at a temperature of about 40° C. to about 200° C., and a pressure of about 3.5 MPa (500 psig) to about 20.7 MPa (3000 psig). The high pressure separator 165 controls the pressure of the hydrocracking zone 115. The finishing reaction zone 155, the EHS 135, and the hydrocracking zone 115 will be at the pressure of the high pressure separator (plus any frictional losses, e.g., about 1.3 MPa (200 psig) at the reactor inlet).

The high pressure separator 165 can provide an overhead stream 170, including primarily gases, and a bottoms stream 175, including primarily liquids.

The bottoms stream 175 is sent to fractionation zone 180 where it is separated into naphtha stream 185, kerosene stream 190, diesel stream 195, and bottoms stream 200.

Bottoms stream 200 can be combined with the bottoms stream 150 from the EHS 135 to form stream 205. Stream 205 can be used as the feed for a fluid catalytic cracking unit or for production of lubricants.

The overhead stream 170 from the high pressure separator 165 can be sent to a purifying zone 210, such as an amine scrubber.

The purified gas 215 from the purifying zone 210 can be combined with make-up hydrogen 220 to form hydrogen stream 110 to the hydrocracking zone 115.

In some embodiments, the conversion of hydrocarbon

In some embodiments, the diesel will have less than about 20 wppm sulfur, or less than about 10 wppm. In some embodiments, the diesel will meet the ultra low sulfur diesel requirement of less than 10 wppm, or it can be blended to meet this requirement.

By the term “about,” we mean within 10% of the value, or 5%, or 1%.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of improving the cold flow properties of diesel comprising:
hydrocracking a hydrocarbon feed in a hydrocracking zone in the presence of a hydrocracking catalyst under hydrocracking conditions to provide a reactor effluent comprising a product mixture comprising diesel, kerosene, and naphtha, and unconverted feed;
separating the reactor effluent in an enhanced hot separator into an overhead vapor stream comprising the product mixture and a liquid bottoms stream comprising the unconverted feed, the enhanced hot separator including a bed of packing;
contacting the overhead vapor stream from the enhanced hot separator with a dewaxing catalyst in a finishing reaction zone to convert a portion of n-paraffins in the product mixture to iso-paraffins;
separating an effluent from the finishing reaction zone in a high pressure separator into an overhead stream comprising gases and a liquid stream comprising the product mixture; and
separating the liquid stream from the high pressure separator into at least a diesel stream in a fractionation zone.

2. The method of claim 1 wherein separating the reactor effluent in the enhanced hot separator further comprises introducing a stripping gas into the enhanced hot separator at a level below the bed of packing.

3. The method of claim 2 wherein the overhead vapor stream from the enhanced hot separator comprises hydrogen, and further comprising:
purifying the hydrogen; and
recycling the hydrogen to at least one of the hydrocracking zone and the enhanced hot separator.

4. The method of claim 3 wherein purifying the hydrogen comprises introducing the overhead stream from the high pressure separator into an amine scrubber to remove hydrogen sulfide from the overhead stream.

5. The method of claim 1 wherein hydrocracking the hydrocarbon feed further comprises hydrotreating the hydrocarbon feed in the hydrocracking zone in the presence of a hydrotreating catalyst before hydrocracking the hydrocarbon feed.

6. The method of claim 1 further comprising:
introducing the reactor effluent into a heat exchanger to exchange heat with the hydrocarbon feed before separating the reactor effluent in the enhanced hot separator.

7. The method of claim 1 wherein separating the liquid stream from the high pressure separator into at least the diesel stream comprises separating the liquid stream from the high pressure separator into at least the diesel stream, a kerosene stream, a naphtha stream, and a bottoms stream.

8. The method of claim 7 further comprising:
combining the bottoms stream from the fractionation zone with the liquid bottoms stream from the enhanced hot separator.

9. The method of claim 1 wherein the diesel stream has less than about 20 wppm sulfur.

10. The method of claim 1 wherein the dewaxing catalyst comprises a non-zeolitic molecular sieve.

11. The method of claim 1 wherein a conversion of the hydrocarbon feed to products boiling below the diesel boiling range is in a range of about 30 to about 60%.

12. A method of improving the cold flow properties of diesel comprising:
hydrotreating and hydrocracking a hydrocarbon feed in a hydrocracking zone in the presence of a hydrotreating catalyst and a hydrocracking catalyst under hydrotreating and hydrocracking conditions to provide a reactor effluent comprising a product mixture comprising diesel, kerosene, and naphtha, and unconverted feed;
separating the reactor effluent in an enhanced hot separator into an overhead vapor stream comprising the product mixture and a liquid bottoms stream comprising the unconverted feed, the enhanced hot separator including a bed of packing, and wherein a stream of hydrogen is introduced into the enhanced hot separator below the bed of packing;
contacting the overhead vapor stream from the enhanced hot separator with a dewaxing catalyst in a finishing reaction zone to convert a portion of n-paraffins in the product mixture to iso-paraffins;
separating an effluent from the finishing reaction zone in a high pressure separator into an overhead stream comprising gases and a liquid stream comprising the product mixture; and
separating the liquid stream from the high pressure separator into at least a diesel stream, a kerosene stream, a naphtha stream, and a bottoms stream in a fractionation zone.

13. The method of claim 12 further comprising:
introducing the reactor effluent into a heat exchanger to exchange heat with the hydrocarbon feed before separating the reactor effluent in the enhanced hot separator.

14. The method of claim 12 wherein the overhead vapor stream from the enhanced hot separator comprises the hydrogen, and further comprising:
purifying the hydrogen; and
recycling the hydrogen to at least one of the hydrocracking zone and the enhanced hot separator.

15. The method of claim 14 wherein purifying the hydrogen comprises introducing the overhead stream from the high pressure separator into an amine scrubber to remove hydrogen sulfide from the overhead stream.

16. The method of claim 12 further comprising:
combining the bottoms stream from the fractionation zone with the liquid bottoms stream from the enhanced hot separator.

17. The method of claim 12 wherein the diesel stream has less than about 10 wppm sulfur.

18. The method of claim 11 wherein the dewaxing catalyst comprises a non-zeolitic molecular sieve.

19. An apparatus for improving the cold flow properties of diesel comprising:
a hydrocracking zone having an inlet and an outlet;
an enhanced hot separator having a fluid inlet, a stripping gas inlet, an overhead outlet, and a bottoms outlet, the fluid inlet of the enhanced hot separator being in fluid communication with the outlet of the hydrocracking zone, the stripping gas inlet being in fluid communication with a stripping gas source, the enhanced hot separator containing a bed of packing;
a finishing reactor containing a dewaxing catalyst having an inlet and an outlet, the inlet being in fluid communication with the overhead outlet of the enhanced hot separator;
a high pressure separator having an inlet, a gas outlet, and a liquid outlet, the inlet of the high pressure separator being in fluid communication with the outlet of the finishing reactor; and
a fractionation zone having an inlet and at least one outlet, the inlet of the fractionation zone being in fluid communication with the liquid outlet of the high pressure separator.

20. The apparatus of claim 19 further comprising:
an amine scrubber having an inlet and an outlet, the inlet of the amine scrubber being in fluid communication with the gas outlet of the high pressure separator, and the outlet of the amine scrubber being in fluid communication with the inlet of the hydro cracking zone.
